(19) United States
(12) Patent Application Publication
(10) Pub. No.: US 2006/0093822 A1
(43) Pub. Date: May 4, 2006

(54) Polymer particle with hollow structure and method for fabricating the same

(76) Inventors: Keh-Ying Hsu, Zhongli City (TW); Deng-Guei Hu, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/978,398

(22) Filed: Nov. 2, 2004

(51) Int. Cl. B32B 9/02

(52) U.S. Cl. 428/402.2

(57) ABSTRACT

The present invention discloses a polymer particle with hollow structure which consists of an inner void and a shell region containing acrylate-type copolymer, wherein the shell region is polymerized by an acrylate monomer having a double bond (monomer) with an acrylate monomer having at least two double bonds (crosslinker). The present invention also discloses a method for forming the provided polymer particle with hollow structure, wherein this method employs a diluent which is a good solvent for the monomer and the crosslinker, but poor solvent for the preparing acrylate-type copolymer, so as to form the shell region.

### BACKGROUND OF THE INVENTION

1. Field of the Invention

The present invention is generally related to a polymer particle, and more particularly to a polymer particle with hollow structure and method for fabricating the same.

2. Description of the Prior Art

Monodisperse micron-sized polymer particles have attracted wide interest in many fields, including of standard for calibration, biomedical examinations, chromatographic packings, spacers, jet ink additives, catalytic substrates. Comparing to conventional materials, especially in chromatographic packings or drug carrier, the monodispersity of the particles produced played a crucial role in meeting their original requirements and in obtaining better efficiency. For an example, a micron-sized and hollow-structured polymer particle with a controlled inner void volume can be used as a reservoir for drug. A fixed dose during a specific course of treatment can be reached, leading to a stable curative effect.

Recently, most spherical polymer particles larger than 10 μm are produced by suspension polymerization either in laboratory or industries. However, the size distribution is wide and fairly broad, even after an additional sieving-out process. Therefore, new method to prepare polymer particles with hollow structure and narrow size distribution and uniformly porosity, is no doubt the trend in the future.

### SUMMARY OF THE INVENTION

In accordance with the present invention, a new polymer particle with hollow structure is provided. This particle can meet the requirement of narrow size distribution and uniformly porosity.

One object of the present invention is to employ a diluent which is a good solvent for the monomer and the crosslinker, but poor solvent for the preparing acrylate-type copolymer, so as to form the shell region and the inner void. Moreover, in order to prepare monodisperse and hollow polymer particles, seeded polymerization is proceed in the monodisperse seeds, which has been already swollen by diluent, monomer and crosslinker. During the process, the morphology of this polymer particle and porosity of this polymer particle can be controlled by adjusting the amount of diluent. Therefore, this present invention does have the economic advantages for industrial applications.

Accordingly, the present invention discloses a polymer particle with hollow structure, which consists of an inner void and a shell region containing acrylate-type copolymer, wherein the shell region is polymerized by an acrylate monomer having a double bond (monomer) with an acrylate monomer having at least two double bonds (crosslinker). The present invention also discloses a method for forming the provided polymer particle with hollow structure, wherein this method employs a diluent which is a good solvent for the monomer and the crosslinker, but poor solvent for the preparing acrylate-type copolymer, so as to form the shell region.

### BRIEF DESCRIPTION OF THE DRAWINGS

FIG. 1 is a flow chart of forming a polymer particle with hollow structure in accordance with a second embodiment of the present invention; and

FIG. 2 is a schematic diagram of the formation mechanism of the polymer particle with hollow structure.

### DESCRIPTION OF THE PREFERRED EMBODIMENTS

What is probed into the invention is a polymer particle with hollow structure and method for fabricating the same. Detail descriptions of the production, structure and elements will be provided in the following in order to make the invention thoroughly understood. Obviously, the application of the invention is not confined to specific details familiar to those who are skilled in the polymer particle. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, there is provided a polymer particle with hollow structure, which consists of an inner void and a shell region containing acrylate-type copolymer, wherein the shell region is polymerized by an acrylate monomer having a double bond (monomer) with an acrylate monomer having at least two double bonds (crosslinker). The above-mentioned monomer is selected as anyone or any combination of the following: 2-hydroxyethyl methacrylate(HEMA), methylacrylate, ethyl acrylate, brtylacrylate, octyl acrylate, methyl methacrylate, ethyl methacrylate, butyl methacrylate, isobutyl methacrylate, dimethylaminoethyl methacrylate, hydroxyethyl acrylate(HEA), hydroxypropyl acrylate(HPA), styrene and vinyl acetate. The crosslinker is selected as anyone or any combination of the following: ethylene glycol dimethacrylate (EGDMA), 1,3 butylene glycol dimethacrylate (BGDMA), 1,4-butane diol diacrylate (BDDA), 1,6-hexane diol diacrylate (HDDA), hexanediol dimethacrylate (HDDMA), neopentylglycol diacrylate (NPGDA) and trimethylolpropane triacrylate (TMPTA). when total weight of the monomer and the crosslinker is kept constant, the more the crosslinker is added, the more spherical the polymer particle with hollow structure will be. For example, in the case of the monomer, HEMA, and the crosslinker, EGDMA, the amount of EGDMA added is greater than 2.5 wt % of HEMA, the polymer particle with hollow structure was made more spherical. Additionally, as total weight of the monomer and the crosslinker increases, the thickness of the shell region of the polymer particle with hollow structure increases.

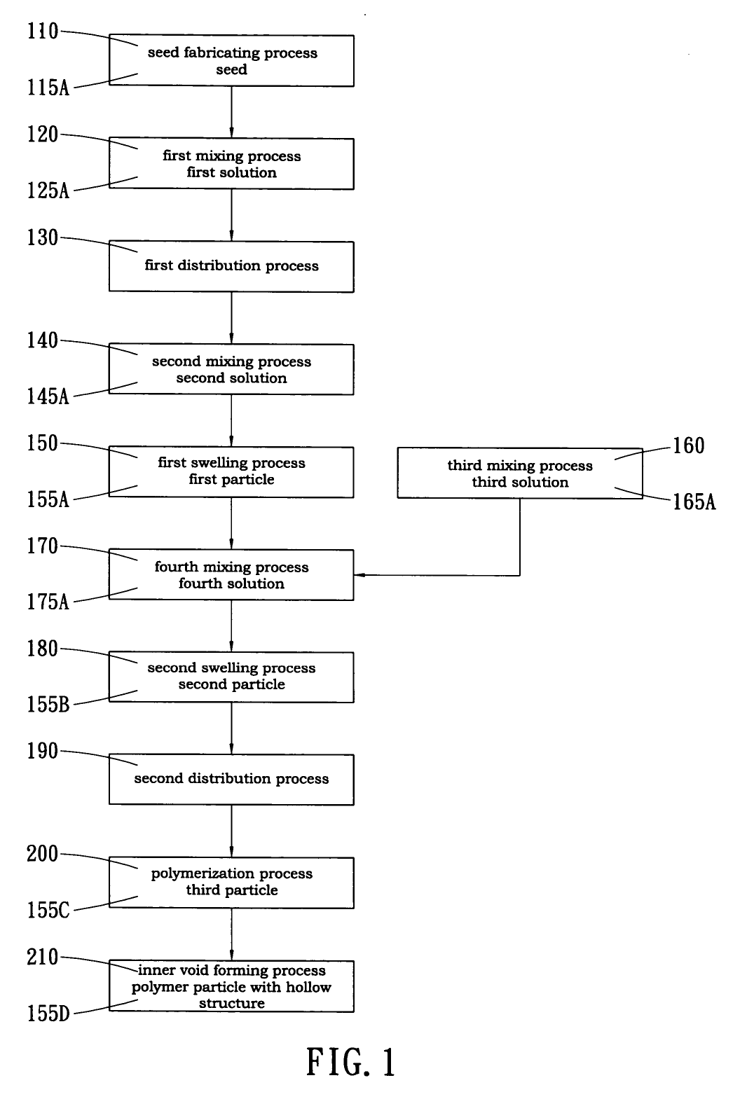

Referring to FIG. 1, in a second embodiment of the present invention, a method for fabricating a polymer particle with hollow structure is provided. First of all, a seed fabricating process 110 is performed to fabricate a seed 115A, wherein the seed 115A is a polystyrene particle with uniform size distribution formed via dispersion polymerization. More particularly, the seed fabricating process 110 further comprises the following: first of all, a styrene monomer, ethanol and a second stabilizer are mixed to form a fifth solution, wherein the second stabilizer is selected from the following group consisting of: polyvinylpyrrolidone (PVP), polyvinyl alcohol (PVA) and anionic surfactant (for example, sodium dodecyl sulfonate, SDS). Then, a second initiator and ethanol are mixed to form a sixth solution, wherein second initiator is selected as any one or any combination of of the following: 2-2′-azobisisobutyronitrile (AIBN), benzoyl peroxide (BPO), chloroperoxidase (CPO), Tert-butylhydroperoxide (t-BuPO), ammonium persulfate (APS), potassium persulfate (KPS) and cumene hydroperoxide (CHP). Finally, the fifth solution and the sixth solution are mixed, and then a polymerization is performed to fabricate the polystyrene particle with uniform size distribution as the seed 115A. In detail, the polymerization is performed under a condition with inert gas purged, wherein the inert gas further comprises nitrogen, and the polymerization temperature is in the range of 50° C. to 70° C.

In this embodiment, after the seed fabricating process 110, a first mixing process 120 is performed to mix the seed 115A, a surfactant and water to form a first solution 125A, wherein the surfactant further comprises an anionic surfactant, such as: sodium dodecyl sulfonate (SDS). Next, a first dispersion process 130 is performed to uniformly disperse the seed 115A in the first solution 125A, wherein the first dispersion process 130 further comprises an ultrasonication step or an agitating step. Then, a second mixing process 140 is performed to add a first initiator and an co-absorbent to the first solution 125A to form a second solution 145A, wherein the co-absorbent is used to help the first initiator swollen into the seed 115A. The above-mentioned first initiator is selected as any one or any combination of of the following: 2-2′-azobisisobutyronitrile (AIBN), benzoyl peroxide (BPO), chloroperoxidase (CPO), Tert-butylhydroperoxide (t-BuPO), ammonium persulfate (APS), potassium persulfate (KPS) and cumene hydroperoxide (CHP). Additionally, the co-absorbent is selected from the group consisting: toluene, benzene and acetone. After the second mixing process 140, a first swelling process 150 is performed to swell the seed 115A and to make the seed 115A absorb the first initiator, whereupon a first particle 155A is formed. The above-mentioned first swelling process 150 further comprises an ultrasonication step or an agitating step, and the operation time of the first swelling process 150 is about 16 hours or longer. Next, a third mixing process 160 is performed to mix a acrylate monomer having a double bond (monomer), a acrylate monomer having at least two double bonds (crosslinker), a diluent, the surfactant and water to form a third solution. The above-mentioned monomer is selected as anyone or any combination of the following: 2-hydroxyethyl methacrylate(HEMA), methylacrylate, ethyl acrylate, brtylacrylate, octyl acrylate, methyl methacrylate, ethyl methacrylate, butyl methacrylate, isobutyl methacrylate, dimethylaminoethyl methacrylate, hydroxyethyl acrylate(HEA), hydroxypropyl acrylate(HPA), styrene and vinyl acetate; The crosslinker is selected as anyone or any combination of the following: ethylene glycol dimethacrylate (EGDMA), 1,3 butylene glycol dimethacrylate (BGDMA), 1,4-butane diol diacrylate (BDDA), 1,6-hexane diol diacrylate (HDDA), hexanediol dimethacrylate (HDDMA), neopentylglycol diacrylate (NPGDA) and trimethylolpropane triacrylate (TMPTA).

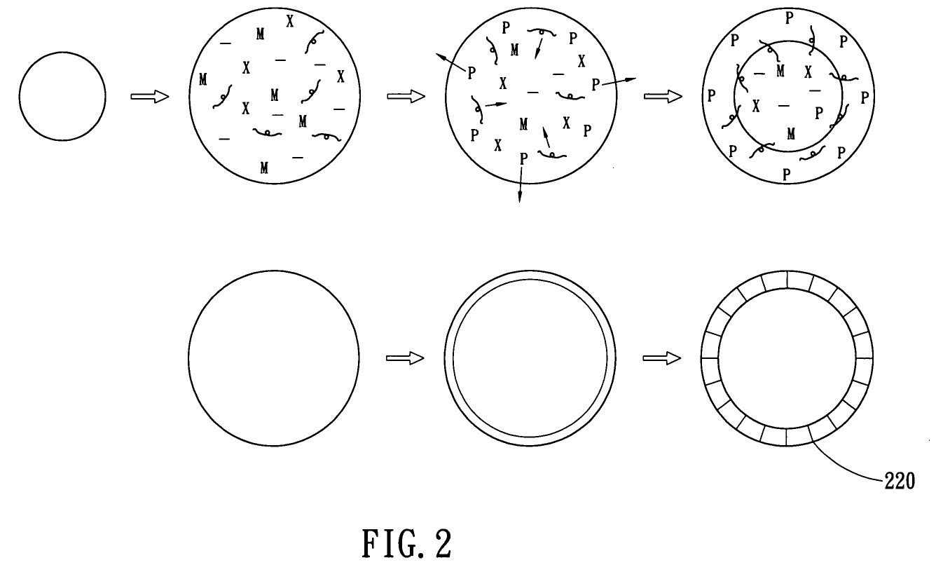

In this embodiment, the above-mentioned diluent is a good solvent for the monomer and the crosslinker, but poor solvent for the acrylate-type copolymer, so as to form the shell region and an inner void, and the diluent is selected from the group consisting: toluene, benzene, hexane, octane and acetone. More particularly, when the diluent is toluene, the amount of the diluent added is greater than total weight of the monomer and the crosslinker, a one-cavity void structure will be formed (220 in FIG. 2). On the other hand, the porosity of the polymer particle with hollow structure increases with the increase of the amount of the diluent added. After the third mixing process 160, a fourth mixing process 170 is performed to mix the second solution 145A and the third solution 165A to form a fourth solution 175A. Then, a second swelling process 180 is performed to swell the first particle 155A, and through which to make the first particle 155A absorb the monomer, the crosslinker and the diluent, whereupon a second particle 155B is formed. Besides, the second swelling process 180 further comprises an ultrasonication step or an agitating step, and the operation time of the second swelling process 180 is about 16 hours or longer. On the other hand, the total weight of the monomer and the crosslinker is controlled from 2 to 40 times the weight of the seed for the design of the final particle morphology and structure.

In this embodiment, after the second swelling process 180, a second dispersion process 190 is performed by adding a first stabilizer to the fourth solution 175A to stabilize the second particle 155B and keep the second particle from aggregation during polymerization, wherein the first stabilizer is selected from the group consisting of: polyvinylpyrrolidone (PVP), polyvinyl alcohol (PVA) and anionic surfactant. Next, in the second particle 155B, a polymerization process 200 is perpolymerized by the monomer and the crosslinker into an acrylate-type copolymer, and a third particle 155C with a shell region is formed, wherein the shell region of the third particle consists of the acrylate-type copolymer. Besides, the polymerization temperature is in the range of 50° C. to 90° C. The above-mentioned polymerization process 200 is performed under a condition with inert gas purged, wherein the inert gas further comprises nitrogen. On the other hand, other unreacted monomer, unreacted crosslinker, polystyrene and the diluent are located inside the third particle. Finally, at least one inner void forming process 210 is performed to remove the diluent, co-absorbent, polystyrene, unreacted monomer, unreacted crosslinker, unreacted first initiator, acrylate oligomer, the first stabilizer, the surfactant and other impurities from the third particle 155C, so as to form the polymer particle with hollow structure 155D. The above-mentioned at least one inner void forming process 210 further comprises a extraction step and a cleaning step, wherein the extraction step is performed to remove the diluent, the co-absorbent, polystyrene, unreacted monomer, unreacted crosslinker, unreacted first initiator and acrylate oligomer from the third particle 155C by a extracting solvent, and the extracting solvent further comprises toluene or benzene. Additionally, the operation temperature range of the extraction step is about 100° C. to 120° C., and the operation time of the extraction step is about 36 hours or longer. Next, the cleaning step is performed to remove the first stabilizer, the surfactant and other impurities from the third particle 155C by a cleaning agent, so as to form the polymer particle with hollow structure, wherein the cleaning agent further comprises methanol.

Referring to FIG. 2 which is a schematic diagram of the formation mechanism of the polymer particle with hollow structure: (A) Initially, the linear polystyrene seed [symbol] is swelled by monomer (M), crosslinker (X), initiator and diluent (−), so as to form a sphere (B) Next, a polymerization process is performed, the monomer and the crosslinker were polymeried into a acrylate-type copolymer (P). The formed acrylate-type copolymer moves toward the outer part of the sphere surface (where near the aqueous phase) due to its hydrophilicity, whereupon most of formed acrylate-type copolymer are located on the interface between polystyrene and aqueous phase. On the contrary, polystyrene and diluent move toward the core of the sphere due to their hydrophobicity, and because only little diluent exists near the surface of the sphere, the acrylate-type copolymer on the interface of the sphere will be precipitated, whereupon a shell region consisting of acrylate-type copolymer is then formed. (C) Finally, the thickness of the shell region increases with the polymerization time increases. Then, performing at least one inner void forming process to remove the diluent, co-absorbent, polystyrene, unreacted monomer, unreacted crosslinker, unreacted first initiator, acrylate oligomer, the first stabilizer, the surfactant and other impurities from the third particle, so as to form the polymer particle with hollow structure. In summary, in the present invention, the desired porosity is formed and designed by the amount of diluent added.

In the above preferred embodiments, the present invention employs a diluent which is a good solvent for the monomer and the crosslinker, but poor solvent for the preparing acrylate-type copolymer, so as to form the shell region and the inner void. Moreover, in order to prepare monodisperse and hollow polymer particles, a polymerization is proceed into monodisperse seeds which has been already swollen by diluent, monomer and crosslinker. During the process, the morphology of this polymer particle and porosity of this polymer particle can be controlled by adjusting the amount of diluent. Therefore, this present invention does have the economic advantages for industrial applications.

To sum up, the present invention discloses a polymer particle with hollow structure which consists of an inner void and a shell region containing acrylate-type copolymer, wherein the shell region is polymerized by an acrylate monomer having a double bond (monomer) with an acrylate monomer having at least two double bonds (crosslinker). The present invention also discloses a method for forming the provided polymer particle with hollow structure, wherein this method employs a diluent which is a good solvent for the monomer and the crosslinker, but poor solvent for the preparing acrylate-type copolymer, so as to form the shell region.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A polymer particle with hollow structure, comprising:
An inner void; and
A shell region containing acrylate-type copolymer, wherein said shell region is polymerized by an acrylate monomer having a double bond (monomer) with an acrylate monomer having at least two double bonds (crosslinker).

2. The structure according to claim 1, wherein said monomer is selected as anyone or any combination of the following: 2-hydroxyethyl methacrylate(HEMA), methylacrylate, ethyl acrylate, brtylacrylate, octyl acrylate, methyl methacrylate, ethyl methacrylate, butyl methacrylate, isobutyl methacrylate, dimethylaminoethyl methacrylate, hydroxyethyl acrylate(HEA), hydroxypropyl acrylate(HPA), styrene and vinyl acetate.

3. The structure according to claim 1, wherein said crosslinker is selected as anyone or any combination of the following: ethylene glycol dimethacrylate (EGDMA), 1,3 butylene glycol dimethacrylate (BGDMA), 1,4-butane diol diacrylate (BDDA), 1,6-hexane diol diacrylate (HDDA), hexanediol dimethacrylate (HDDMA), neopentylglycol diacrylate (NPGDA) and trimethylolpropane triacrylate (TMPTA).

4. The structure according to claim 1, wherein when total weight of said monomer and said crosslinker is kept constant, the more said crosslinker is added, the more spherical said polymer particle with hollow structure will be.

5. The structure according to claim 4, when said monomer is HEMA and said crosslinker is EGDMA, the amount of EGDMA added is greater than 2.5 wt % of HEMA.

6. The structure according to claim 1, wherein when total weight of said monomer and said crosslinker increases, the thickness of said shell region of said polymer particle with hollow structure increases.

7. A method for fabricating a polymer particle with hollow structure, comprising:
performing a seed fabricating process to fabricate a seed, which is a polystyrene particle with uniform size distribution formed via dispersion polymerization;
mixing said seed, a surfactant and water to form a first solution, and performing a first dispersion process to uniformly disperse said seed in said first solution;
adding a first initiator and a co-absorbent to said first solution to form a second solution, wherein said co-absorbent is used to help said first initiator swollen into said seed;
performing a first swelling process to swell said seed, and through which to make said seed absorb said first initiator, whereupon a first particle is formed;
mixing an acrylate monomer having a double bond (monomer), an acrylate monomer having at least two double bonds (crosslinker), a diluent, said surfactant and water to form a third solution;
mixing said second solution and said third solution to form a fourth solution, and performing a second swelling process to swell said first particle, and through which to make said first particle absorb said monomer, said crosslinker and said diluent, whereupon a second particle is formed;
performing a second dispersion process by adding a first stabilizer to stabilize said second particle and keep said second particle from aggregation during polymerization in said fourth solution;
in said second particle, performing a polymerization process by polymerizing said monomer and said crosslinker into a acrylate-type copolymer, and a third particle with a shell region is formed, wherein said shell region of said third particle consists of said acrylate-type copolymer, additionally, other unreacted monomer, unreacted crosslinker, polystyrene and said diluent are located inside said third particle; and
performing at least one inner void forming process to remove said diluent, co-absorbent, polystyrene, unreacted monomer, unreacted crosslinker, unreacted first initiator, acrylate oligomer, said first stabilizer, said surfactant and other impurities from said third particle, so as to form said polymer particle with hollow structure.

8. The method according to claim 7, wherein said seed fabricating process further comprises:
mixing a styrene monomer, ethanol and a second stabilizer to form a fifth solution;
mixing a second initiator and ethanol to form a sixth solution; and
mixing said fifth solution and said sixth solution, and performing a polymerization to form said polystyrene particle with uniform size distribution as said seed.

9. The method according to claim 8, wherein said second stabilizer is selected from the group consisting of: polyvinylpyrrolidone (PVP), polyvinyl alcohol (PVA) and anionic surfactant.

10. The method according to claim 8, wherein said second initiator is selected as any one or any combination of of the following: 2-2′-azobisisobutyronitrile (AIBN), benzoyl peroxide (BPO), chloroperoxidase (CPO), Tert-butylhydroperoxide (t-BuPO), ammonium persulfate (APS), potassium persulfate (KPS) and cumene hydroperoxide (CHP).

11. The method according to claim 8, wherein said polymerization is performed under a condition with inert gas purged.

12. The method according to claim 8, wherein the polymerization temperature ranges from 50° C. to 70° C.

13. The method according to claim 7, wherein said surfactant further comprises sodium dodecyl sulfonate (SDS).

14. The method according to claim 7, wherein said first dispersion process further comprises an ultrasonication step or an agitating step.

15. The method according to claim 7, wherein said first initiator is selected as any one or any combination of of the following: 2-2′-azobisisobutyronitrile (AIBN), benzoyl peroxide (BPO), chloroperoxidase (CPO), Tert-butylhydroperoxide (t-BuPO), ammonium persulfate (APS), potassium persulfate (KPS) and cumene hydroperoxide (CHP).

16. The method according to claim 7, wherein said co-absorbent is selected from the group consisting: toluene, benzene and acetone.

17. The method according to claim 7, wherein said first dispersion process further comprises an ultrasonication step or an agitating step.

18. The method according to claim 7, wherein said monomer is selected as anyone or any combination of the following: 2-hydroxyethyl methacrylate(HEMA), methylacrylate, ethyl acrylate, brtylacrylate, octyl acrylate, methyl methacrylate, ethyl methacrylate, butyl methacrylate, isobutyl methacrylate, dimethylaminoethyl methacrylate, hydroxyethyl acrylate(HEA), hydroxypropyl acrylate(HPA), styrene and vinyl acetate.

19. The method according to claim 7, wherein said crosslinker is selected as anyone or any combination of the following: ethylene glycol dimethacrylate (EGDMA), 1,3 butylene glycol dimethacrylate (BGDMA), 1,4-butane diol diacrylate (BDDA), 1,6-hexane diol diacrylate (HDDA), hexanediol dimethacrylate (HDDMA), neopentylglycol diacrylate (NPGDA), trimethylolpropane triacrylate (TMPTA).

20. The method according to claim 7, wherein total weight of said monomer and said crosslinker is about 2 to 40 times the weight of said seed.

21. The method according to claim 7, wherein said diluent is a good solvent for said monomer and said crosslinker, but poor solvent for said acrylate-type copolymer, so as to form said shell region and an inner void.

22. The method according to claim 7, wherein said diluent is selected from the group consisting: toluene, benzene, hexane, octane and acetone.

23. The method according to claim 7, wherein when said diluent is toluene, the amount of said diluent to add is greater than total weight of said acrylate monomer having a double bond and said acrylate monomer having at least two double bonds, a one-cavity void structure will be formed.

24. The method according to claim 7, wherein the porosity of said polymer particle with hollow structure increases with increasing amount of said diluent added.

25. The method according to claim 7, wherein said second swelling process further comprises an ultrasonication step or an agitating step.

26. The method according to claim 7, wherein said first stabilizer is selected from the group consisting of: polyvinylpyrrolidone (PVP), polyvinyl alcohol (PVA) and anionic surfactant.

27. The method according to claim 7, wherein the polymerization temperature is in the range of 50° C. to 90° C.

28. The method according to claim 7, wherein said polymerization process is performed under a condition with inert gas purged.

29. The method according to claim 7, wherein at least one said inner void forming process further comprises:
performing a extraction step to remove said diluent, said co-absorbent, polystyrene, unreacted acrylate monomer having a double bond, unreacted acrylate monomer having at least two double bonds, unreacted first initiator and acrylate oligomer from said third particle by a extracting solvent; and
performing a cleaning step to remove said first stabilizer, said surfactant and other impurities from said third particle by a cleaning agent, so as to form said polymer particle with hollow structure.

30. The method according to claim 29, wherein said extracting solvent further comprises toluene or benzene.

31. The method according to claim 29, wherein the operation temperature range of said extraction step is about 100° C. to 120° C.

32. The method according to claim 29, wherein the operation time of said extraction step is about 36 hours or longer.

33. The method according to claim 29, wherein said cleaning agent further comprises methanol.
